(19) United States
(12) Patent Application Publication
(10) Pub. No.: US 2009/0127422 A1
(43) Pub. Date: May 21, 2009

(54) Method and apparatus for mounting overhead display unit

(75) Inventor: Akitoshi Kitazawa, Torrance, CA (US)

Correspondence Address: Yasuo Muramatsu;MURAMATSU & ASSOCIATES, 114 Pacifica, Suite 310, Irvine, CA, 92618, US

(73) Assignee: Alpine Electronics, Inc.

(21) Appl. No.: 12/321,404

(22) Filed: Jan. 21, 2009

Related U.S. Application Data
(63) Continuation of application No. 11/203,798, filed on Aug. 15, 2005.

(51) Int. Cl. B42F 13/00

(52) U.S. Cl. 248/324; 248/343

(57) ABSTRACT

A method and apparatus enables a user to easily mount an overhead display unit on a pair of mounting rails formed on the ceiling of a vehicle. The display screen can be rotated and retracted into a receptacle formed between the mounting rails so that the elongated side of the display unit is stored therein in parallel with the mounting rails. The longer side of the display unit is stored in the receptacle in parallel with the pair of mounting rails. One embodiment uses a turntable for rotatably mounting the display screen where the display screen is attached to the turntable substantially apart from a center of the turntable. Another embodiment has a rotary disk at the back of a display screen to turn the display screen after the display is pulled out from the receptacle.

This is a continuation of prior U.S. patent application Ser. No. 11/203,798 filed Aug. 15, 2005, which is incorporated herein by reference.

### FIELD OF THE INVENTION

This invention relates to a method and apparatus for mounting an overhead display unit, and more particularly, to a method and apparatus for mounting an overhead display unit on a pair of mounting rails formed on the ceiling of a vehicle where the display unit can be rotated and retracted into a receptacle formed between the mounting rails so that the elongated side of the display unit is in parallel with the mounting rails.

### BACKGROUND OF THE INVENTION

As audio and video technologies advance, demands for mounting audio and video devices on a vehicle become higher and higher for enjoyment of music, movies, games, etc., in the vehicle. Normally, such an audio and video device (entertainment device) comprises a display unit or monitor, a speaker, and a playback device such as a CD player or a DVD player. This invention is directed to a method and structure for mounting the entertainment device, especially a display unit thereof, on the vehicle.

One of methods for mounting such a display unit is a technique of mounting an overhead display unit on the ceiling of a vehicle. In this method, a display unit is stored in a receptacle formed on a casing when not in use while the display unit is pivotally turned downwardly to a deployed viewing position to allow a user (passenger) to watch the display screen.

An example of such a display unit is shown in a perspective view of FIG. 1. An overhead display unit 41 in the conventional technology is generally comprised of a display screen 53, a screen frame 51, a receptacle (recess) 45, a hinge portion 121, and a casing 46. The casing 46 is securely mounted on the ceiling of a vehicle through a mounting mechanism (not shown).

FIG. 1 shows a deployment position of the overhead display unit 41 where the display screen 53 is retracted from the receptacle 45 by pivoting about the hinge portion 121 downwardly. Thus, the display screen 53 is positioned at an optimum angle for viewing so that a user can watch the images on the display screen 53. When the display unit 41 is not in use, the user presses the display screen 53 upwardly so that the display screen 53 is rotated about the hinge portion 121. Thus, the display screen 53 is received in the receptacle 45, thereby settling the display unit 41 on the ceiling of the vehicle.

The overhead display unit (monitor) has the advantage in that it can effectively use a space in a ceiling area of the vehicle. When in use, the display screen is rotated downwardly, and not in use, the display screen is retracted to be flat on the ceiling. However, an overhead display unit in the conventional technology has a drawback in that the process of the installation on the ceiling is relatively complex and requires special tools and technique.

Recently, a mounting system has been proposed which allows a user to easily mount various devices on the vehicle. In this system, a pair of mounting rails are provided to a structural portion of a vehicle, such as on a ceiling, to which devices and components can be mounted thereon. An example of such a mounting rail system is disclosed by the U.S. Pat. No. 6,669,260. The basic configuration of such a rail mounting system 10 is illustrated in the perspective view of FIG. 2.

In the mounting system 10 of FIG. 2, a pair of mounting rails 115 are provided on the ceiling 111 of a vehicle in a manner to run in a front-back direction of a vehicle. Moldings 113 and 119 cover the forward and backward ends of the mounting rails 115. The mounting rails 115 are securely attached to the ceiling 111 through attachment means such as screws (not shown).

The mounting rails 115 function to attach desired component 117 such as a display unit in a manner that recesses or indented portions (not shown) formed on the component 117 hold the mounting rails 115. Electrical power and signals can be supplied to the component 117 through cables hidden in the mounting rails 115. Any components can be attached freely at a desired position to the mounting rails 115 as long as the component has suitable mounting parts (recesses) that can fit with the mounting rails 115. A shape and size of the mounting rails 115 and a width between the two mounting rails 115 are generally standardized to allow manufacturers to produce standardized components that can be easily mounted on the standardized mounting system 10.

Since this standardized mounting system allows to easily mount a component with a sufficient strength while achieving an aesthetic effect, there is a demand to mount a display unit on this type of mounting system. However, as the distance between the two the mounting rails 115 is generally fixed to a relatively small amount, there is a problem in that a large display unit cannot be mounted on this system. Namely, because a display screen has to be received within a space between the two mounting rails 115, the horizontal length of the display is limited by the distance between the two mounting rails. Thus, a large display unit having the conventional structure of FIG. 1 cannot be mounted on the mounting rail system 10.

Therefore, there is a need of a new mounting method and structure which is capable of mounting a large display unit on the standard mounting rail system. There is a need of a new mounting method and apparatus for mounting a display unit whose horizontal length is larger than the distance between the two mounting rails.

### SUMMARY OF THE INVENTION

It is, therefore, an object of the present invention to provide a method and apparatus for installing a display unit on the mounting rail system where a horizontal length of the display screen is larger than the distance between the mounting rails.

It is another object of the present invention to provide a method and apparatus for mounting a display unit on the mounting rail system where a base of the display screen is able to rotate so that the vertical length of the display screen can be fit in the distance between the two mounting rails when not in use.

It is a further object of the present invention to provide a method and apparatus for mounting a display unit on the mounting rail system where a base of the display screen is able to rotate so that the horizontal length of the display screen larger than the distance between the mounting rails can be deployed when in use.

The mounting method and apparatus enables a user to easily mount an overhead display unit on a pair of mounting rails formed on the ceiling of a vehicle. The display screen can be rotated and retracted into a receptacle formed between the mounting rails so that the elongated side of the display unit is stored therein in parallel with the mounting rails. As a result, the display unit having a horizontal size larger than the distance between the two mounting rails can be mounted on the standard mounting system on the ceiling of the vehicle.

One aspect of the present invention is a method for mounting an overhead display unit on a ceiling of a vehicle. The method is comprised of the steps of; attaching a pair of mounting rails in parallel on a ceiling of a vehicle in a front and back direction of the vehicle; mounting the display unit on the mounting rails by clamping the mounting rails by indented portions formed on the display unit; rotating a display screen of the display unit so that a horizontal direction of the display screen is in parallel with the mounting rails when storing the display screen within a space between the pair of mounting rails; and pivoting one end of the display screen downwardly and rotating the display screen so that the horizontal direction of the display screen is in perpendicular to the direction of the pair of mounting rails when viewing the display screen. A size and a shape of the mounting rails and a distance between the pair of mounting rails are standardized in industry.

The step of rotating the display screen includes a step of rotating a turntable mounting the display screen in a predetermined direction by a predetermined angle so that the display screen faces a user in the vehicle. The display screen is attached to the turntable through a hinge portion at an outer area of the turntable substantially apart from a center of the turntable. The turntable is attached in parallel with the ceiling of the vehicle to a receptacle formed on the display unit.

The step of pivoting one end of the display screen includes a step of pivoting the display screen about the hinge portion downwardly at about 90 degrees so that the display screen is opened relative to a receptacle on the display unit.

In another embodiment, the step of rotating the display screen includes a step of rotating the display screen through a rotary disk formed on an extension portion at the back of the display screen so that a longer side of the display screen is in a right and left direction of the vehicle when facing a user in the vehicle. The display screen is attached to the extension portion through the rotary disk so that the display screen is rotatable relative to the extension portion. This embodiment further comprises the step of adjusting a height of the display screen by retracting the extension portion upwardly.

The step of pivoting the display screen includes a step of pivoting the display screen about a hinge portion downwardly at about 90 degrees so that the display screen is opened relative to a receptacle on the display unit, wherein the hinge portion is formed at an end of the extension portion and connected to the display unit at a front side thereof. The display screen is rotatably attached to the extension portion at about a center thereof so that the display unit rotates in perpendicular to the ceiling of the vehicle after pivoting downwardly.

Another aspect of the present invention is an apparatus for mounting an overhead display unit on the ceiling of the vehicle for implementing the various steps defined in the mounting method of the present invention noted above. The mounting apparatus allows a user to easily attach the display unit on the pair of standardized mounting rails on the ceiling of the vehicle.

According to the present invention, the mounting method and apparatus allows the display unit having a large screen to be mounted on a narrow area in the vehicle. Especially, the display unit having a horizontal size larger than the distance between the two mounting rails can be mounted on the standard mounting system on the ceiling of the vehicle. The base of the display screen of the display unit on the mounting system is able to rotate so that the vertical length of the display screen can be fit in the distance between the two mounting rails when not in use by orienting the horizontal direction of the display screen in parallel with the mounting rails. By the rotation of the screen base, the display screen having the horizontal length larger than the distance between the mounting rails can be deployed to the viewing position when in use.

### BRIEF DESCRIPTION OF THE DRAWINGS

FIG. 1 is a perspective view showing an example of an overhead monitor to be mounted on the ceiling of a vehicle in a conventional technology where the monitor screen can be rotated downwardly about a hinge for viewing.

FIG. 2 is a perspective view showing a mounting rail system comprising mounting rails that are attached to the ceiling of a vehicle to attach a component thereto at any desired location.

FIGS. 3A-3C are perspective views showing the process of pulling down a display screen to the viewing position and vice versa in one embodiment of the present invention. FIG. 3A shows the condition wherein the display screen is stored in a receptacle, FIG. 3B shows the condition where the display screen is opened by rotating downwardly from the receptacle, and FIG. 3C shows the deployment position where the base of the display screen is rotated relative to a base for an optimum viewing angle.

FIG. 4A is a bottom view of the display unit in the embodiment of FIGS. 3A-3C in the present invention, and FIG. 4B is a front view of the display unit in the embodiment of FIGS. 3A-3C in the present invention.

FIGS. 5A-5D are perspective views showing the process of pulling down a display screen to the viewing position and vice versa in another embodiment of the present invention. FIG. 5A shows the condition where the display screen is stored in a receptacle, FIG. 5B shows the condition where the display screen is pulled out from the receptacle. FIG. 5C shows the display screen after rotating on an extension portion, and FIG. 5D shows the deployment position of the display screen wherein the extension portion is retracted to an optimum vertical position,

FIG. 6 is a plan bottom showing an example of structure of the display unit in the embodiment of FIGS. 5A-5D in the present invention.

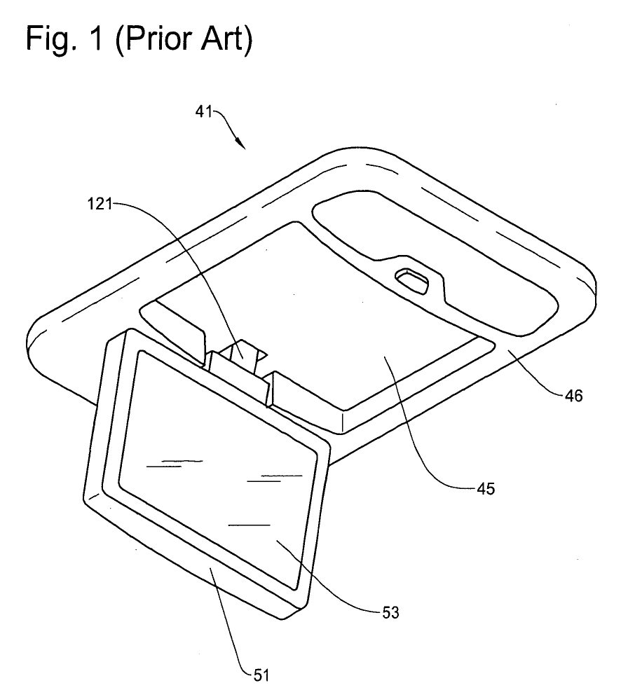

### DETAILED DESCRIPTION OF THE INVENTION

The present invention will be described in detail with reference to the accompanying drawings. The display unit (overhead monitor) mounting apparatus and method in the present invention aims to mount a display unit having a large display screen to an area that is limited in space. The display screen has a horizontal length substantially larger than the vertical length. Further, the present invention aims to provide the display unit mounting method and apparatus suited for the display unit on a standardized mounting system using a pair of mounting rails attached to the ceiling of a vehicle.

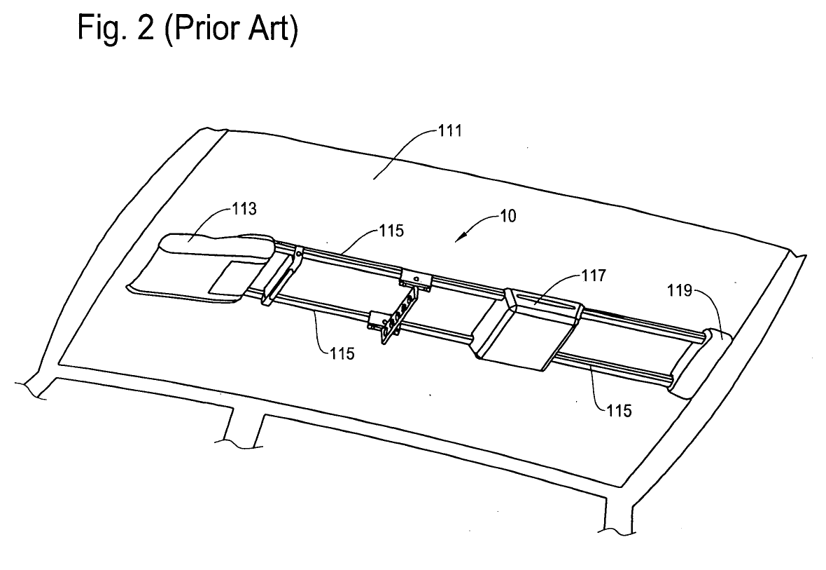

A display unit in general has a horizontal length that is larger than a vertical length. Especially, it is a recent trend that a display unit has a much wider horizontal display range than a vertical display range to achieve a panoramic view or a screen image similar to the movie theater. Because of the standardized width between the mounting rails 115 shown in FIG. 2, the size of the display unit that can be mounted on such modular systems is limited by the width because the display unit must be fit in the space created between the mounting rails. Thus, in the conventional technology, the distance between the mounting rails limits the horizontal length (width) of the display unit. The mounting method and apparatus of the present invention overcomes this shortcoming by changing the orientation of the display screen when retracted in a receptacle.

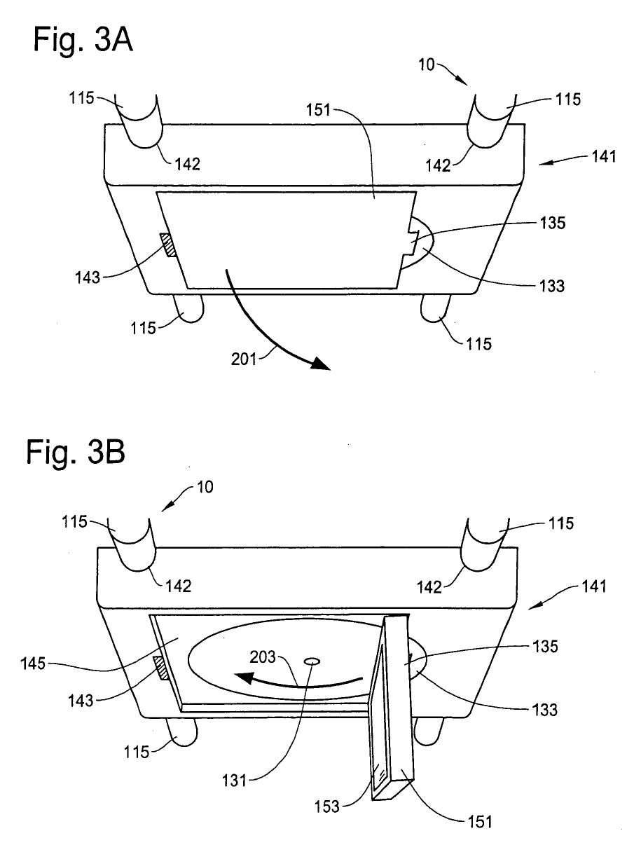

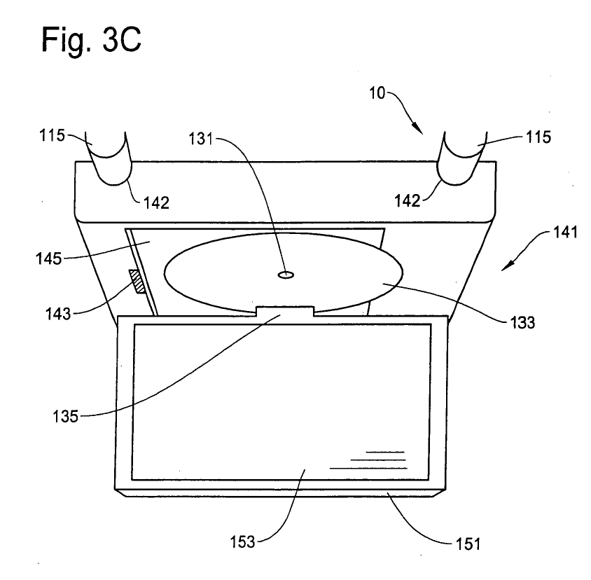

FIGS. 3A to 3C are perspective views showing an embodiment of the present invention to mount an overhead monitor (display unit) on the standardized mounting rail system. A display unit 141 is mounted on a pair of mounting rails 115 of the mounting system 10 in a manner that indented portions 142 of the display unit clamp the mounting rails. As best shown in FIG. 3C, the display unit 141 is comprised of a receptacle 145, a turntable (screen base) 133, a spindle 131, a knob 143, a hinge portion 135, a screen frame 151, and a display screen 153. The display screen 153 is mounted on the turntable 133 through the hinge portion 135. As shown in FIGS. 3A-3C, the hinge portion 135 which is attached to an outer area of the turntable 133 apart from the spindle 131.

Although not shown, signal cables and power lines running in the mounting rails 115 are connected to the display unit 141. The mounting rails 115 are attached to the ceiling of the vehicle in the manner described with reference to FIG. 2. The mounting rails 115 are attached to the ceiling in a front and back direction of the vehicle which is also referred to hereafter as a rail direction. The position of the display screen 153 depicted in FIG. 3C is also referred to hereafter as a deployment position in which a user can watch the display screen 153.

FIG. 3A shows a situation where the display screen 53 is stored in the receptacle 145 when the display unit 141 is not in use. The receptacle 145 is a space (recess) created between the mounting rails 115 to receive the display screen 153. The hinge portion 135 connects the screen frame 151 and the turn table 133 and allows the screen frame 151 to pivotally move thereabout so that the display screen 153 opens or closes relative to the receptacle 145. Since the display screen 153 is completely retracted in the receptacle 145, FIG. 3A only shows a back surface of the display screen 153.

In the embodiment of FIGS. 3A-3C, it should be noted that the horizontal side of the display screen 153 is in the rail direction when the display screen 153 is stored in the receptacle 145. In other words, the horizontal direction of the display screen 153 is in parallel with the mounting rails 115 of the mounting system 10. An arrow 201 indicates the direction of force exerted to the screen frame 151 by the user to open the display screen 153 by pivoting downwardly. The knob 143 is provided at the edge of the receptacle 145 to place a finger thereon to pull the display screen 153.

FIG. 3B is a perspective view showing the situation where the screen frame 151 having the display screen 153 is pivotally moved about the hinge portion 135 for deployment. Thus, the display screen 153 is now in the vertical direction although the screen is not facing the user. The turn table (base) 133 mounting the display screen 153 is designed to rotate about the spindle 131. An arrow 203 indicates the direction of force to be exerted to the turn table 133 and the display screen 153, i.e., the direction of turn, to change the direction of the display screen to face the user. In this case, the user rotates the turn table 133 clockwise by about 90 degrees.

FIG. 3C is the deployment position of the display unit 41 in the first embodiment of the present invention. The display screen 153 now faces the user since the display screen 153 has been turned by about 90 degrees from the position shown in FIG. 3B. In other words, the horizontal direction of the display screen is now in perpendicular to the direction of the mounting rails. Thus, a longer side of the display screen 153 is in a right and left direction of the vehicle when facing a user in the vehicle when in use. When not in use, the display screen 53 having a horizontal width larger than the distance between the mounting rails 115 can be retracted in the receptacle 145 or deployed to the viewing position in the manner described above.

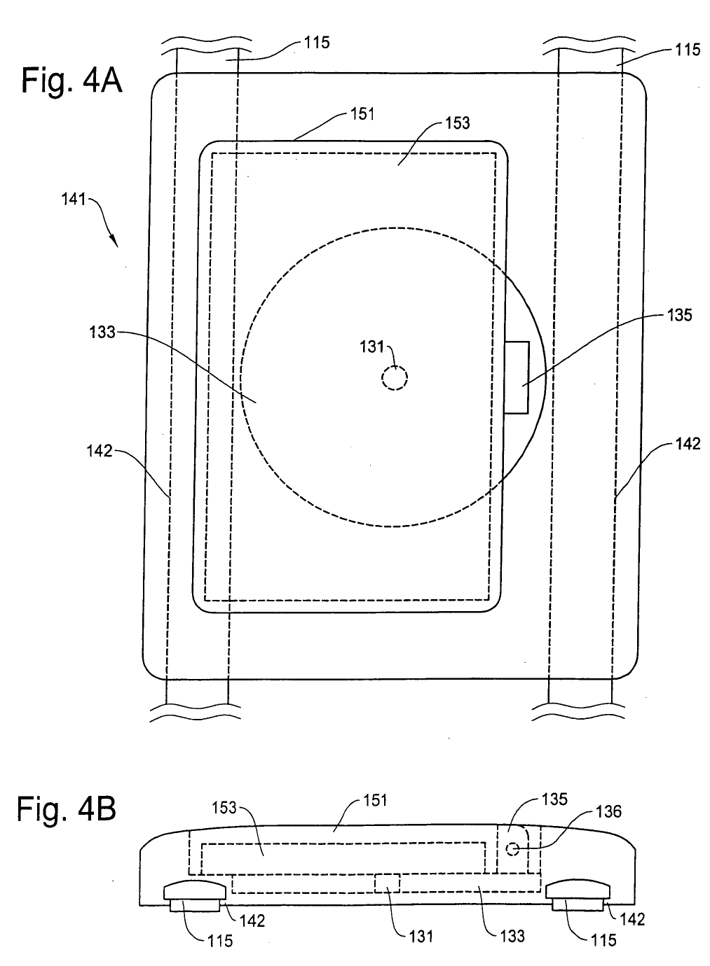

FIG. 4A shows a plan view of the display unit 141 in the first embodiment of the present invention. The plan view of FIG. 4A shows the condition corresponding to the perspective view of FIG. 3A where the display screen 153 (screen frame 151) is stored in the receptacle 145. The display unit 141 is attached to the mounting rails 115 of the mounting system 10, which are securely attached to the ceiling of the vehicle. As noted above, the display unit 141 is configured by the display screen 153, screen frame 151, turn table 133, spindle 131, and hinge portion 135. As shown, the hinge portion 135 is attached to an outer area of the turntable 133 far away from the spindle 131.

The horizontal side of the display screen 153 is in the rail direction, i.e., in parallel with the mounting rails 115. The turn table 133 has the spindle 131 at the center thereof that acts as a rotation center. The turn table 133 and the spindle 131 are located substantially at the center of the display unit 141. The spindle 131 allows the turn table 133 to rotate so that the display screen 153 can change direction to face the user. The display screen 153 (screen frame 151) can pivot at the hinge portion 135 so that the display screen 153 can be deployed from the receptacle 145 for viewing the same or retracted in the receptacle 145 for storing the same.

FIG. 4B is a front view of the display unit 141 corresponding to FIG. 4A. As noted above, the display unit 141 is attached to the mounting rails 115. The hinge portion 135 has a pivot shaft 136. The pivot shaft 136 allows the display screen 153 to pivotally rotate thereabout in the manner shown in FIG. 3B.

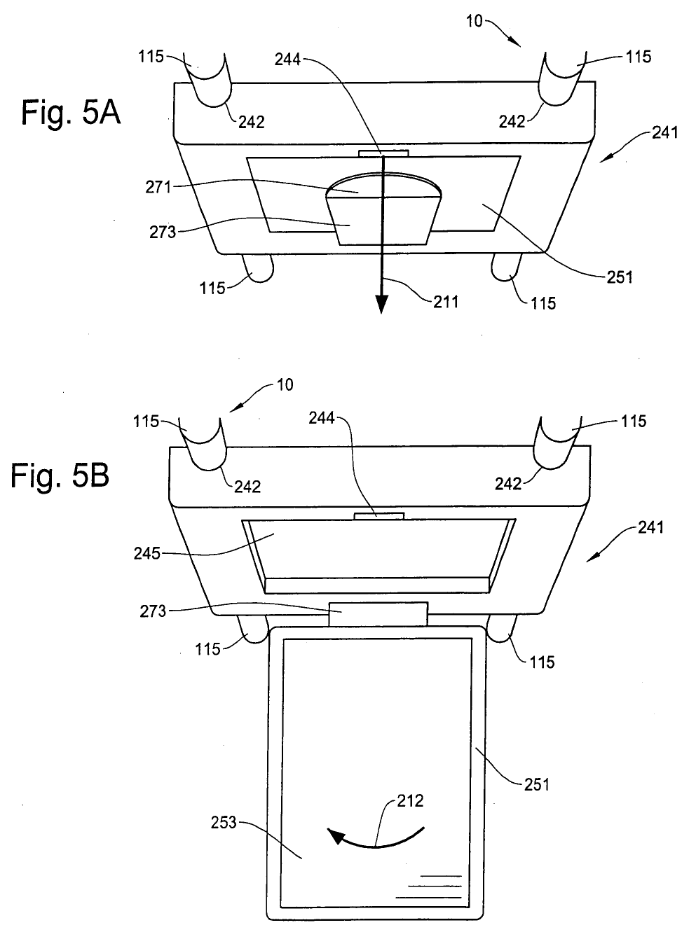

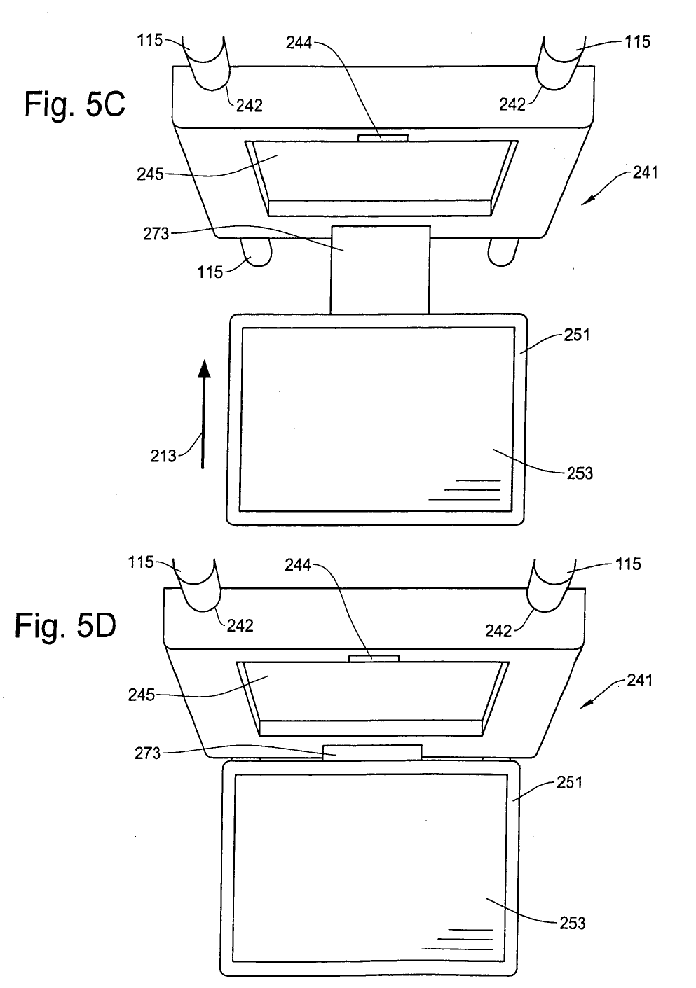

FIGS. 5A-5D show another embodiment of the present invention for mounting the display unit (overhead monitor) on the ceiling of the vehicle. In FIGS. 5A-5D, a display unit 241 is attached to the mounting rails 115 of the rail mounting system 10 that is attached to the ceiling of the vehicle. The position of the display screen depicted in FIG. 5A is a retracted situation when not in use and the position of the display screen depicted in FIG. 5D is a deployment situation when in use.

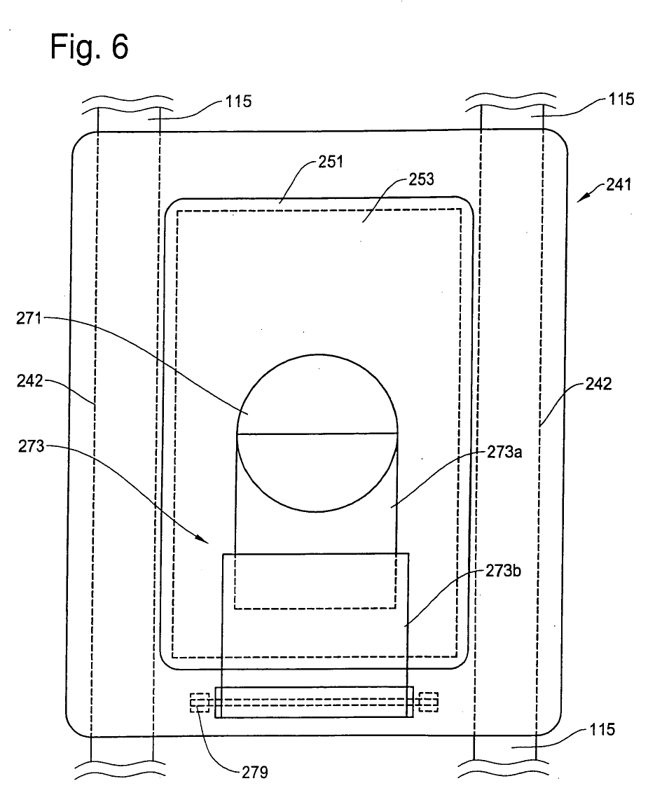

The display unit 241 is mounted on the pair of mounting rails 115 in a manner that indented portions 242 of the display unit clamp the mounting rails 115. The display unit 241 is comprised of a receptacle 245, a rotary disk 271, an extension portion 273, a knob 244, a hinge portion 279 (FIG. 6), a screen frame 251, and a display screen 253. The extension portion 273 is connected to the housing of the display unit 241 through the hinge portion 279. In this example, the hinge portion 279 and the extension portion 273 are located at the front end of the display unit 241.

Referring now to FIG. 5A, the rotary disk 271 is shown which is rotatably mounted on the extension portion 273. The display screen 253 (screen frame 251) and the rotary disk 271 fixedly connected to one another so that when the rotary disk 271 rotates, the display screen 253 rotates as well. Thus, the rotary disk 271 functions to turn the display screen 253 so that the display screen 253 can have the angle between the retracted situation and the deployment situation.

A user will pull the display screen 253 downward as indicated by an arrow 211. The knob 244 is provided at the side of the receptacle 245 to allow the user to place his finger and easily pull out the display screen 253. One end of the extension portion 273 is pivotally connected to the housing of the display unit 241. Thus, the display screen of the display unit 241 is rotated downwardly.

FIG. 5B shows the condition where the display screen 253 is pulled out from the receptacle 245 of the display unit 241. More precisely, the end of the display screen 253 proximal to the user is pulled down while the other end distal to the user is rotatably jointed to the display unit 241 (hinge portion 279 of FIG. 6) through the extension portion 273. The receptacle 245 is formed in the space between the mounting rails 115. As shown in FIGS. 5A and 5B, the display screen 253 is stored in the receptacle 245 in a manner that the horizontal (width) direction of the screen is in the rail direction (parallel with the mounting rails 115).

The display screen 253 now faces the user, however, the horizontal direction of the screen is in the vertical direction. As noted above, as most of the display screens, the display unit 241 is so designed to have a wider horizontal range than a vertical range. Thus, the user turns the display screen 253 in the direction shown by an arrow 212. In this case, the display screen is rotated in the clockwise direction by 90 degrees. It is also possible to rotate the display screen in the counterclockwise direction by 270 degrees for the same purpose. This rotation is made possible by the rotary disk 271 rotatably connected to the extension portion 273.

FIG. 5C shows the display unit 241 of the present invention where the display screen 253 is turned clockwise by 90 degrees from the situation of FIG. 5B. The display screen 253 is now wide in the horizontal direction as intended for viewing. In FIG. 5C, the extension portion 273 is fully extended downwardly for rotating the display screen 253. Thus, after the rotation, the extension portion 273 can be seen in an elongated manner in FIG. 5C and the display screen 253 may be too low or distract the driver's rear view. Thus, if necessary, the user can shorten the extension portion 273 by pushing the display screen 253 upwardly as indicated by an arrow 213.

The final deployment situation is shown in the perspective view of FIG. 5D. The display screen 253 is placed at vertically higher position than that shown in FIG. 5C since the extension portion 273 is retracted in the display unit 241 in the previous step. As a result, a display screen 253 that is wide in the horizontal direction is positioned close to the ceiling for viewing, i.e., a longer side of the display screen 253 is in a right and left direction of the vehicle when facing a user in the vehicle when in use.

FIG. 6 shows a plan view of the display unit 241 in second embodiment of the present invention. The plan view of FIG. 6 shows the condition corresponding to the perspective view of FIG. 5A where the display screen 253 (screen frame 251) is stored in the receptacle 245. The display unit 241 is attached to the mounting rails 115 of the mounting system 10 which are securely attached to the ceiling. As noted above, the display unit is configure by the display screen 253, screen frame 251, rotary disk 271, extension portion 273, and hinge portion 279. The rotary disk 271 allows the display screen 253 to rotate relative to the extension portion 273.

As shown in FIG. 5B, the rotary disk 271 allows the display screen 253 to rotate clockwise by 90 degrees. The rotary disk 271 may also be designed to allow the rotation in both clockwise and counterclockwise directions. When the display screen 253 is turned 90 degrees, the position may be fixed by a latching mechanism (not shown). The hinge portion 279 connects the extension portion 273 to the housing of the display unit 241. The hinge portion 279 allows the extension portion 273 to rotate thereabout as shown in FIG. 5B. As shown, the hinge portion 279 is located at the front end of the display unit 241.

The extension portion 273 can take any form as long as it can serve its purpose of extending and contracting to change its length, i.e., the vertical position of the display screen 253. In the preferred embodiment shown in FIG. 6, the extension portion 273 is made of two parts, a slide plate 273a and a plate carrier 273b. The extension portion 273 is so configured that the slide plate 273a is slidably moved and fixed to a desired position in the plate carrier 273b.

As has been described above, according to the present invention, the mounting method and apparatus allows the display unit having a large screen to be mounted on a narrow area. Especially, the display unit having a horizontal size larger than the distance between the two mounting rails can be mounted on the standard mounting system on the ceiling of the vehicle. The base of the display screen of the display unit on the mounting system is able to rotate so that the vertical length of the display screen can be fit in the distance between the two mounting rails when not in use by orienting the horizontal direction of the display screen in parallel with the mounting rails. By the rotation of the screen base, the display screen having the horizontal length larger than the distance between the mounting rails can be deployed to the viewing position when in use.

Although the present invention is described herein with reference to the preferred embodiments, one skilled in the art will readily appreciate that various modifications and variations may be made without departing from the spirit and the scope of the present invention. Such modifications and variations are considered to be within the purview and scope of the appended claims and their equivalents.

1. A method for mounting an overhead display unit on a ceiling of a vehicle, comprising the following steps of:
attaching a pair of mounting rails in parallel on a ceiling of a vehicle in a front and back direction of the vehicle;
mounting the display unit on the mounting rails by clamping the mounting rails by indented portions formed on the display unit;
rotating a display screen of the display unit so that a horizontal direction of the display screen is in parallel with the mounting rails when storing the display screen within a space between the pair of mounting rails; and
pivoting one end of the display screen downwardly and rotating the display screen so that the horizontal direction of the display screen is in perpendicular to the direction of the pair of mounting rails when viewing the display screen;
wherein said step of rotating the display screen includes a step of rotating the display screen through a rotary disk formed on an extension portion so that a longer side of the display screen is in a right and left direction of the vehicle when facing a user in the vehicle.

2. A method for mounting an overhead display unit as defined in claim 1, wherein said step of rotating the display screen includes a step of rotating a turntable mounting the display screen which is rotated in a predetermined direction by a predetermined angle so that the display screen faces a user in the vehicle for viewing the display screen.

3. A method for mounting an overhead display unit as defined in claim 2, wherein said display screen is attached to the turntable through a hinge portion which is positioned at an outer area of the turntable substantially apart from a center of the turntable.

4. A method for mounting an overhead display unit as defined in claim 2, wherein said turntable is attached in parallel with the ceiling of the vehicle to a receptacle formed on the display unit.

5. A method for mounting an overhead display unit as defined in claim 3, wherein said step of pivoting one end of the display screen includes a step of pivoting the display screen about the hinge portion downwardly at about 90 degrees so that the display screen is opened relative to a receptacle on the display unit for viewing the display screen.

6. (canceled)

7. A method for mounting an overhead display unit as defined in claim 1, wherein said display screen is attached to the extension portion through the rotary disk so that the display screen is rotatable relative to the extension portion.

8. A method for mounting an overhead display unit as defined in claim 1, wherein said step of pivoting the display screen includes a step of pivoting the display screen about a hinge portion downwardly at about 90 degrees so that the display screen is opened relative to a receptacle on the display unit, wherein the hinge portion is formed at an end of the extension portion and connected to the display unit at a front side thereof.

9. A method for mounting an overhead display unit as defined in claim 8, wherein said display screen is rotatably attached to the extension portion at about a center thereof so that the display unit rotates in perpendicular to the ceiling of the vehicle after pivoting downwardly.

10. A method for mounting an overhead display unit as defined in claim 1, further comprising the step of adjusting a height of the display screen by retracting the extension portion upwardly.

11. An apparatus for mounting an overhead display unit on a ceiling of a vehicle, comprising:
a pair of mounting rails attached in parallel to a ceiling of a vehicle in a front and back direction of the vehicle;
indented portions formed on the display unit for attaching the display unit to the mounting rails by clamping the mounting rails;
a rotating member for rotating a display screen of the display unit so that a horizontal direction of the display screen is in parallel with the mounting rails when storing the display screen within a space between the pair of mounting rails; and
a pivoting member connected to said rotating member for pivoting one end of the display screen downwardly when viewing the display screen and for rotating the display screen so that the horizontal direction of the display screen is in perpendicular to the direction of the pair of mounting rails when viewing the display screen;
wherein said rotating member for rotating the display screen includes a rotary disk formed on an extension portion to rotate the display screen so that a longer side of the display screen is in a right and left direction of the vehicle when facing a user in the vehicle.

12. An apparatus for mounting an overhead display unit as defined in claim 11, wherein said rotating member for rotating the display screen includes a turntable mounting the display screen to rotate in a predetermined direction by a predetermined angle so that the display screen faces a user in the vehicle for viewing the display screen.

13. An apparatus for mounting an overhead display unit as defined in claim 12, wherein said display screen is attached to the turntable through a hinge portion which is positioned at an outer area of the turntable substantially apart from a center of the turntable.

14. An apparatus for mounting an overhead display unit as defined in claim 12, wherein said turntable is attached to a receptacle formed on the bottom portion of the display unit in parallel with the ceiling of the vehicle.

15. An apparatus for mounting an overhead display unit as defined in claim 13, wherein said pivoting member for pivoting one end of the display screen includes a pivoting unit for pivoting the display screen about the hinge portion downwardly at about 90 degrees so that the display screen is opened relative to a receptacle on the display unit for viewing the display screen.

16. (canceled)

17. An apparatus for mounting an overhead display unit as defined in claim 11, wherein said display screen is attached to the extension portion through the rotary disk so that the display screen is rotatable relative to the extension portion.

18. An apparatus for mounting an overhead display unit as defined in claim 11, wherein said pivoting member for pivoting the display screen includes a hinge portion for pivoting the display screen downwardly at about 90 degrees so that the display screen is opened relative to a receptacle on the display unit, wherein the hinge portion is formed at an end of the extension portion and connected to the display unit at a front side thereof.

19. An apparatus for mounting an overhead display unit as defined in claim 18, wherein said display screen is rotatably attached to the extension portion at about a center thereof so that the display unit rotates in perpendicular to the ceiling of the vehicle after pivoting downwardly.

20. An apparatus for mounting an overhead display unit as defined in claim 11, wherein the extension portion is so configured that a length thereof is adjustable for adjusting a height of the display screen by retracting the extension portion upwardly.
